(19) United States
(12) Patent Application Publication
(10) Pub. No.: US 2026/0023298 A1
(43) Pub. Date: Jan. 22, 2026

(54) OPTICAL MODULATION DEVICE AND LASER RADAR

(71) Applicant: HON HAI PRECISION INDUSTRY CO., LTD., New Taipei (TW)

(72) Inventor: YU-FONG YU, New Taipei (TW)

(21) Appl. No.: 19/259,322

(22) Filed: Jul. 3, 2025

(30) Foreign Application Priority Data
Jul. 18, 2024 (CN) 202410964662.4

(51) Int. Cl. G02F 1/29; G01S 7/481

(52) U.S. Cl. CPC G02F 1/292; G01S 7/4814

(57) ABSTRACT

An optical modulation device includes a light reflection layer, a conductive layer, a dielectric layer, and a driving module. A side of the light reflection layer is configured for receiving a first light. The conductive layer is on a side of the light reflection layer and includes a first conductive layer and a second conductive layer. The dielectric layer includes a first dielectric layer and a second dielectric layer. The driving module is configured to apply a first voltage to the light reflection layer, apply a second voltage to the first conductive layer, and apply a third voltage to the second conductive layer. The driving module is configured to change a voltage difference between the light reflection layer and the conductive layer, so as to modulate the first light into a second light.

### FIELD

The subject matter herein relates to a field of laser radar technology, particularly relates to an optical modulation device and a laser radar having the optical modulation device.

### BACKGROUND

In a laser radar system, optical phased arrays (OPAs) enable beam scanning without mechanical rotation. The laser radar has broad application prospects in laser ranging and free-space optical communication. However, when using voltages to control both optical phase and beam deflection angle, to achieve greater deflection angles requires higher driving voltages of the driver module. When using a single-layer structure of OPAs, the higher the driving voltage, the greater the power consumption of the driving module, thereby reducing a lifespan of the laser radar and increasing manufacturing cost. Therefore, there is room for improvement in the art. dr

### BRIEF DESCRIPTION OF THE DRAWINGS

Implementations of the present technology will now be described, by way of embodiments only, with reference to the attached figures.

FIG. 1 is a schematic view of an optical modulation device according to a first embodiment of the present disclosure.

FIG. 2 is a schematic view of an optical modulation device according to a second embodiment of the present disclosure.

FIG. 3 is a schematic view of the structure of an optical modulation device according to a third embodiment of the present disclosure.

FIG. 4 is a schematic view of a deflection angle of a second light in an embodiment of the present disclosure.

FIG. 5 is a schematic view of another deflection angle of the second light in an embodiment of the present disclosure.

FIG. 6 is a schematic view of a laser radar according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

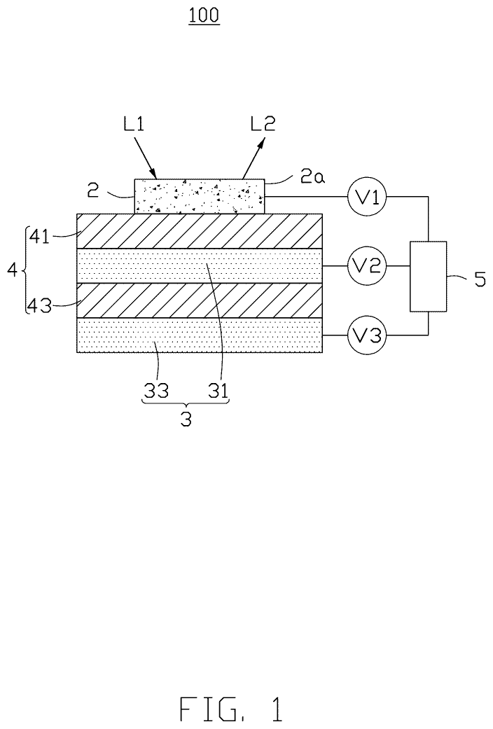

FIG. 1 illustrates an optical modulation device 100. The optical modulation device 100 includes a light reflection layer 2, a conductive layer 3, and a dielectric layer 4 stacked together. The light reflection layer 2 includes a first side and a second side opposite to the first side. The first side of the light reflection layer 2 is used to receive a first light L1. The conductive layer 3 includes a first conductive layer 31 and a second conductive layer 33 spaced apart from each other. The conductive layer 3 is arranged on a second side of the light reflection layer 2. The dielectric layer 4 includes a first dielectric layer 41 and a second dielectric layer 43 spaced apart from each other. The first dielectric layer 41 is between the light reflection layer 2 and the first conductive layer 31, and configured for electrically isolating the light reflection layer 2 from the first conductive layer 31. The second dielectric layer 43 is between the first conductive layer 31 and the second conductive layer 33. The second dielectric layer 43 is configured for electrically isolating the first conductive layer 31 from the second conductive layer 33. The optical modulation device 100 also includes a driving module 5 electrically connected to the light reflection layer 2 and the conductive layer 3. The driving module 5 applies a first voltage V1 to the light reflection layer 2, applies a second voltage V2 to the first conductive layer 31, and applies a third voltage V3 to the second conductive layer 33. The driving module 5 is used to change a voltage difference between the light reflection layer 2 and the conductive layer 3, so as to modulate the first light L1 into a second light L2 on a side surface of the light reflection layer 2.

The optical modulation device 100 in the first embodiment can easily regulate the first light L1 by setting the light reflection layer 2, the conductive layer 3, and the dielectric layer 4 at intervals, and using the driving module 5 to change the voltage difference between the light reflection layer 2 and the conductive layer 3. This is beneficial for reducing a power consumption of the driving module 5, thereby extending a lifespan of the optical modulation device 100, and reducing a cost of the optical modulation device 100.

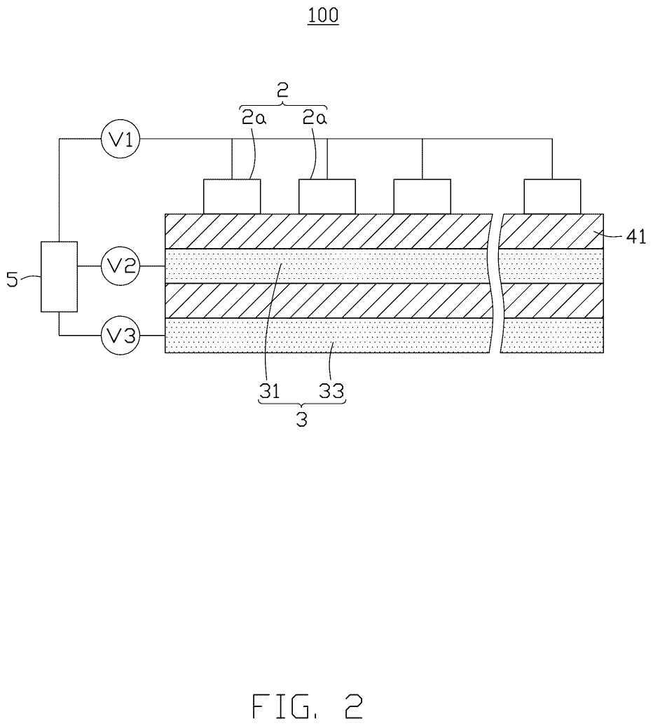

FIG. 1 shows the light reflection layer 2 includes a light reflection unit 2a. As shown in FIG. 2, the light reflection layer 2 includes a plurality of light reflection units 2a spaced apart from each other. The light reflection units 2a are arranged on the first dielectric layer 41 and spaced apart from each other. The light reflection units 2a form an array structure on a surface of the first dielectric layer 41. By the driving module 5 changing the voltage difference between the light reflection layer 2 and the conductive layer 3, light can be deflected in different directions. In this embodiment, the driving module 5 applies the first voltage V1 to each light reflection unit 2a in parallel. In other embodiments, the driving module 5 can independently apply the first voltage V1 to each light reflection unit 2a.

The dielectric layer 4 is made of an insulating material. The insulation material is non-conductive materials under an allowable voltage, but it is not absolutely non-conductive material. Under a certain external electric field strength, the insulation material can also undergo processes such as conduction, polarization, loss, breakdown, etc., and long-term use can also cause aging. The first dielectric layer 41 and the second dielectric layer 43 may be made of insulating material including at least one of polypropylene, polyethylene, polyvinyl chloride, polyester, silicon oxide, silicon nitride, silicon nitride oxide, aluminum oxide, and zirconium oxide. In this embodiment, the first dielectric layer 41 and the second dielectric layer 43 are made of a same material. In other embodiments, the first dielectric layer 41 and the second dielectric layer 43 are made of different materials.

The light reflection layer 2, the conductive layer 3, and the dielectric layer 4 are connected in a stacked manner. The light reflection layer 2 is made of a conductive material. In this embodiment, the material of the light reflection layer 2 includes electro-optic material that is optical functional material with electro-optic effects. The change in refractive index of the light reflecting layer 2 under the action of an external electric field is called the electro-optic effect. In this embodiment, the material of the light reflection layer 2 may include any one of potassium dihydrogen phosphate (DKDP), ammonium dihydrogen phosphate (ADP), gallium arsenide (GaAs), cadmium telluride (CdTe), and lithium tantalate (LT) crystals as electro-optic materials. In other embodiments, the material of the light reflection layer 2 may include a metal material having high conductivity. For example, the metal material can any one of copper (Cu), aluminum (Al), nickel (Ni), iron (Fe), cobalt (Co), zinc (Zn), titanium (Ti), ruthenium (Ru), rhodium (Rh), palladium (Pd), platinum (Pt), silver (Ag), osmium (Os), iridium (Ir), and gold (Au), or an alloy made of at least two of the above metals. In addition, the material of the light reflection layer 2 can also include any one of graphene, carbon nanotubes (CNT), and conductive oxides.

The driving module 5 can use any one of a switching power supply, an inverter power supply, an AC stabilized power supply, a DC stabilized power supply, and a DC/DC power supply as power supply.

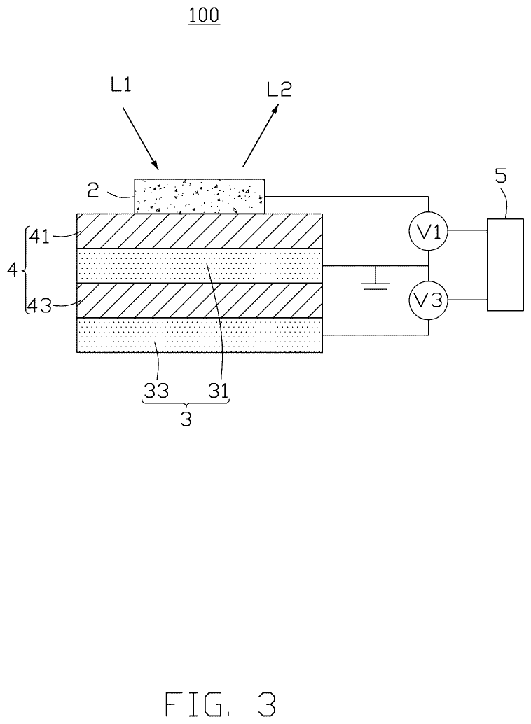

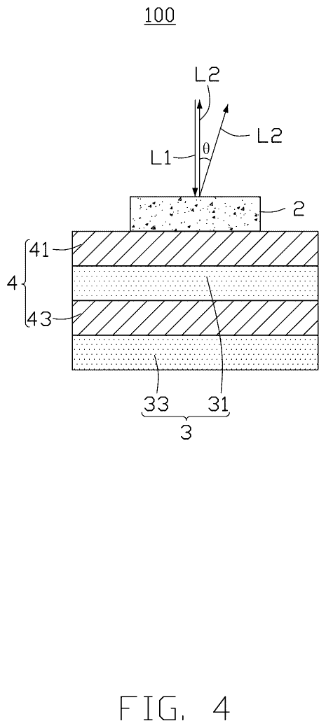

As shown in FIG. 3 and FIG. 4, the first conductive layer 31 is grounded, and the second voltage V2 is a ground voltage. One of the first voltage V1 and the third voltage V3 is a positive voltage, and the other of the first voltage V1 and the third voltage V3 is a negative voltage. When the second voltage V2 on the first conductive layer 31 is zero V, the third voltage V3 applied to the second conductive layer 33 by the driving module 5 is a negative voltage, and the first voltage V1 applied to the light reflection layer 2 by the driving module 5 is a positive voltage. The difference in charge concentration between the light reflection layer 2 and the second conductive layer 33 results in a voltage difference. When the first light L1 is modulated into the second light L2 on the surface of the light reflection layer 2, a characteristics of the second light L2 relative to the first light L1 change according to the charge concentration of the light reflection layer 2 and the second conductive layer 33. That is, a deflection angle θ of the second light L2 relative to the first light L1 can be controlled by adjusting the voltage of the driving module 5. In other embodiments, the first voltage V1 is a negative voltage, and the third voltage V3 is a positive voltage.

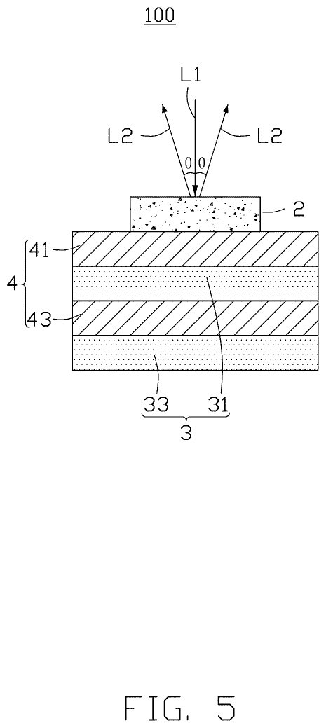

The first light L1 is incident perpendicular to the light reflection layer 2. The deflection angle θ of emitted light is changed by changing the voltage difference between the light reflection layer 2 and the conductive layer 3. The deflection angle θ of the second light L2 relative to the first light L1 is in a range from 0° to 30°. A reflection phase of the second light L2 relative to the first light L1 changes according to the above voltage difference, and the phase variation range of the second light L2 is in a range from 0 to 2π. Please refer to FIG. 5, the first light L1 is incident perpendicular to the light reflection layer 2, and the deflection angle θ of the second light L2 relative to the first light L1 is in a range from −15° to 15°. The phase variation of the second light L2 is in a range from 0to 2π. Please refer to FIG. 1, a thickness of the light reflection layer 2 is in a range from 10 μm to 100 ƒm. The thickness of each of the first conductive layer 31 and the second conductive layer 33 is in a range from 10 μm to 100 ∥m. The thickness of the light reflection layer 2 and the conductive layer 3 depends on the voltage applied by the driving module 5. When the magnitude of the first voltage V1, the second voltage V2, and the third voltage V3 is greater, the light reflection layer 2 and the conductive layer 3 can be thicker. When the light reflection layer 2 and the conductive layer 3 are thick, it is beneficial for reducing a difficulty of processing. When the magnitude of the first voltage V1, the second voltage V2, and the third voltage V3 are less, the light reflection layer 2 and the conductive layer 3 can be thinner. The thickness of each of the first dielectric layer 41 and the second dielectric layer 43 is in a range from 10 μm to 100 μm. The optical modulation device 100 can easily regulate the first light L1 by using the driving module 5 to change the voltage difference between the light reflection layer 2 and the conductive layer 3, which is beneficial for reducing the power consumption of the driving module 5, thereby extending the lifespan of the optical modulation device 100, and reducing the cost of the optical modulation device 100.

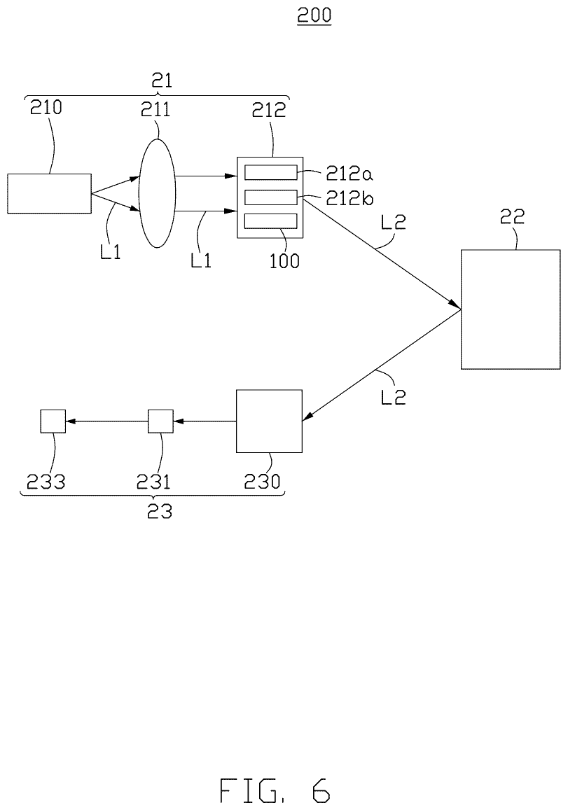

FIG. 6 illustrates a laser radar 200. The laser radar 200 includes a laser emitting system 21 and a laser receiving system 23. The laser emission system 21 includes a light source 210, a collimation module 211, and an optical phased array module 212. The light source 210 emits the first light L1, and the first light L1 enters the collimation module 211. The collimation module 211 collimates the first light L1. The first light L1 after collimated is incident on the optical phased array module 212. The optical phased array module 212 is used to change the direction of the first light L1, thereby achieving the scanning function of the laser radar 200. The optical phased array module 212 includes a splitter 212a, an optical modulation device, and an optical waveguide 212b. The optical modulation device 100 is installed in the optical phased array module 212 for modulating the first light L1 into the second light L2. The first light L1 enters the optical waveguide 212b by the splitter 212a, and the optical waveguide 212b transmits the first light L1 to the optical modulation device 100. The optical modulation device 100 changes the voltage difference between the light reflection layer 2 and the conductive layer 3 by the driving module 5, thereby changing the deflection angle θ and the phase of the first light L1, and the first light L1 is modulated into the second light L2. The difference between the second light L2 and the first light L1 lies in the phase and deflection angle θ. The optical phased array module 212 is used to control the scanning direction of the second light L2. The second light L2 is emitted from the optical phased array module 212 into free space and reflected by an external object 22.

The laser receiving system 23 receives the second light L2 reflected back by the external object 22. The laser receiving system 23 includes an optical amplifier 230, a transimpedance amplifier 231, and an analog-to-digital converter 233. The optical amplifier 230 is used to amplify optical signal of the second light L2, convert the optical signal of the second light L2 into current signal and transmit the current signal to the transimpedance amplifier 231. The transimpedance amplifier 231 is used to further amplify the current signal into voltage signal. The voltage signal is finally passed through the analog-to-digital converter 233. The analog-to-digital converter 233 is used to convert continuous analog signals into discrete digital signals, facilitating signal processing and data conversion, and facilitating computer control and calculation.

The laser radar 200 provided in the embodiments of the present disclosure can easily regulate the first light L1 by setting the optical modulation device 100 having any of the above embodiments, which is beneficial for reducing an overall power consumption of the laser radar 200, thereby extending the lifespan of the laser radar 200, and reducing the cost of the laser radar 200.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An optical modulation device comprising:
a light reflection layer, a first side of the light reflection layer configured for receiving a first light;
a conductive layer comprising a first conductive layer and a second conductive layer, both the first conductive layer and the second conductive layer being located on a second side of the light reflection layer, the second side being opposite to the first side;
a dielectric layer comprising a first dielectric layer and a second dielectric layer, the first dielectric layer being between the light reflection layer and the first conductive layer, the second dielectric layer being between the first conductive layer and the second conductive layer;
a driving module electrically connected to each of the light reflection layer, the first conductive layer, and the second conductive layer, the driving module configured to apply a first voltage to the light reflection layer, apply a second voltage to the first conductive layer, and apply a third voltage to the second conductive layer;
wherein the driving module is further configured to change a voltage difference between the light reflection layer and the conductive layer, so as to modulate the first light into a second light.

2. The optical modulation device of claim 1, wherein the second voltage is a ground voltage.

3. The optical modulation device of claim 2, wherein one of the first voltage and the third voltage is a positive voltage, and another one of the first voltage and the third voltage is a negative voltage.

4. The optical modulation device of claim 1, wherein the light reflection layer comprises a plurality of light reflection units spaced apart from each other.

5. The optical modulation device of claim 4, wherein the plurality of light reflection units form an array structure on a surface of the first dielectric layer.

6. The optical modulation device of claim 1, wherein the first side of the light reflection is positioned to receive the first light perpendicular to the light reflection layer, a deflection angle of the second light relative to the first light is in a range from 0° to 30°.

7. The optical modulation device of claim 1, wherein the first side of the light reflection is positioned to receive the first light perpendicular to the light reflection layer, a deflection angle of the second light relative to the first light is in a range from −15° to 15°.

8. The optical modulation device of claim 1, wherein each of the first dielectric layer and the second dielectric layer is made of insulating material.

9. The optical modulation device of claim 1, wherein each of the light reflection layer and the conductive layer is made of conductive material.

10. A laser radar, comprising:
a laser emitting system comprising a light source and an optical phased array module, the light source configured to emit a first light, the optical phased array module comprising a splitter, an optical modulation device, and an optical waveguide; the optical modulation device comprising:
a light reflection layer, a first side of the light reflection layer configured for receiving a first light;
a conductive layer comprising a first conductive layer and a second conductive layer, both the first conductive layer and the second conductive layer being located on a second side of the light reflection layer, the second side being opposite to the first side;
a dielectric layer comprising a first dielectric layer and a second dielectric layer, the first dielectric layer being between the light reflection layer and the first conductive layer, the second dielectric layer being between the first conductive layer and the second conductive layer;
a driving module electrically connected to each of the light reflection layer, the first conductive layer and the second conductive layer, the driving module configured to apply a first voltage to the light reflection layer, apply a second voltage to the first conductive layer, and apply a third voltage to the second conductive layer;
wherein the driving module is further configured to change a voltage difference between the light reflection layer and the conductive layer, so as to modulate the first light into a second light.

11. The laser radar of claim 10, wherein the second voltage is a ground voltage.

12. The laser radar of claim 11, wherein one of the first voltage and the third voltage is a positive voltage, and another one of the first voltage and the third voltage is a negative voltage.

13. The laser radar of claim 10, wherein the light reflection layer comprises a plurality of light reflection units spaced apart from each other.

14. The laser radar of claim 13, wherein the plurality of light reflection units form an array structure on a surface of the first dielectric layer.

15. The laser radar of claim 10, wherein the first side of the light reflection is positioned to receive the first light perpendicular to the light reflection layer, a deflection angle of the second light relative to the first light is in a range from 0° to 30°.

16. The laser radar of claim 10, wherein the first side of the light reflection is positioned to receive the first light perpendicular to the light reflection layer, a deflection angle of the second light relative to the first light is in a range from −15° to 15°.

17. The laser radar of claim 10, wherein each of the first dielectric layer and the second dielectric layer is made of insulating material.

18. The laser radar of claim 10, wherein each of the light reflection layer and the conductive layer is made of conductive material.
